(19) United States
(12) Patent Application Publication
(10) Pub. No.: US 2026/0211889 A1
(43) Pub. Date: Jul. 23, 2026

(54) SYSTEM FOR CONTROLLING RESPONSE RELIABILITY

(71) Applicant: Google LLC, Mountain View, CA (US)

(72) Inventors: Danny Karmon, Petach Tikva (IL); Ilia Labzovsky, Tel Aviv-Yafo (IL)

(21) Appl. No.: 19/035,455

(22) Filed: Jan. 23, 2025

(51) Int. Cl. G06F 16/2457; G06N 20/00

(52) U.S. Cl. CPC G06F 16/24578; G06N 20/00

(57) ABSTRACT

Disclosed implementations for incorporating source reliability and credibility information into the response generation process of search engine systems. In one example, a plurality of snippets responsive to a query are received. Each snippet of the plurality of snippets is associated with a credibility score. A response to the query is generated by processing the plurality of snippets and associated credibility scores through a generative model that includes a mask/attention layer configured to adjust attention weights associated with the plurality of snippets based on the respective credibility scores. The response to the query via the search system.

### BACKGROUND

Generative models (e.g., generative artificial intelligence (GenAI) and language models) are machine-learning models trained to generate a response (estimate the probability of a sequence of tokens, including words and/or emoji) in response to a prompt. Such language models have a high number of parameters (e.g., billions, hundreds of billions) and are commonly based on a transformer architecture. These models can generate realistic text or image responses to a prompt and can generate entirely new content, referred to as creative content.

### SUMMARY

A technical problem with leveraging generative models (e.g., a language model) and Retrieval-Augmented Generation (RAG) for information retrieval and response generation in search engine systems is the failure of these models to retain and use the content from sources of intrinsic quality or credibility (e.g., sources of information that are responsive to a query). Specifically, the significance metrics, such as retriever scores or credibility ratings, associated with documents retrieved from a source are not effectively maintained within the generative model’s context window. This disconnection between the retrieved information and its reliability can lead to the search engine processing and reasoning over sources without adequately considering their varying levels of credibility. As a result, the generated search responses may inadvertently propagate misinformation or low-quality information, undermining the user's trust in the search engine and the reliability of the provided results.

Accordingly, in an example implementation, a plurality of snippets responsive to a query are received. Each snippet of the plurality of snippets is associated with a credibility score. A response to the query is generated by processing the plurality of snippets and associated credibility scores through a generative model that includes a mask/attention layer configured to adjust attention weights associated with the plurality of snippets based on the respective credibility scores. The response to the query via the search system.

In another example implementation, a response based on a plurality of snippets responsive to a query and an aggregate score associated with the response is received from a generative model. The aggregate score is determined based on a plurality of credibility scores. Each credibility score of the plurality of credibility scores is associated with a respective snippet of the plurality of snippets. The aggregate score reflects a weight assigned by the generative model to each snippet of the plurality of snippets based on the respective credibility score of the plurality of credibility scores. Feedback from the generative model is generated by processing the response and the aggregate score through a reward model. The feedback is provided as training to the generative model.

In some implementations, the response is a first response and the aggregate score is a first aggregate score. In some implementations, the feedback includes a selection of the first response as a selected response or a selection of a second response as the selected response based on the first aggregate score and a second aggregate score associated with the second response. In some implementations, the reward model is trained to select the first response or the second response as the selected response based on the first aggregate score, the second aggregate score, and a threshold value. In some implementations, the plurality of snippets and the plurality of credibility scores are provided via a search system based on the query. In some implementations, the generative model is trained to provide responses to queries received by the search system.

It is appreciated that methods in accordance with the present disclosure can include any combination of the aspects and features described herein. That is, methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

FIG. 1 depicts an example architecture that can be employed to execute implementations of the present disclosure.

FIG. 2 depicts an example generative system, according to disclosed implementations.

FIG. 3 depicts a flowchart of a non-limiting process that can be performed by implementations of the present disclosure.

FIG. 4 depicts a flowchart of a non-limiting process that can be performed by implementations of the present disclosure.

FIG. 5 depicts an example of a distributed computer device that can be used to implement the described techniques.

### DETAILED DESCRIPTION

Traditional attention mechanisms compute static weights for each part of the input, and this allocation does not change once learned. However, adaptive attention mechanisms enable the model to adjust the focus dynamically during processing. Adaptive attention mechanisms for adjusting a generative model’s attention allocation refer to techniques that enable the model to dynamically allocate (e.g., based on the prompt/query and associated mask) attention to different parts of the input (e.g., the various sources of information) depending on the context, task requirements, or input characteristics. This dynamic adjustment allows the model to focus more on relevant information and reduce the processing of irrelevant or less important details, which can lead to better performance and efficiency. A proposed technique incorporates an adaptive attention mechanism that is guided by significance scores.

In some examples, implementations of the described system employ an adaptive attention mechanism by embedding a mask to dynamically adjust a generative model’s attention allocation based on the embedded (e.g., via a mask) significance scores. Specifically, such implementations may give higher attention weights for text associated with sources having higher credibility scores. The mask focuses the generative model on content from the most reliable sources of information during response generation. Accordingly, implementations described herein can be employed to ensure that search systems, for example, can consistently provide users with high-quality, trustworthy, and credible information, thereby meeting the expectations and needs of modern information seekers.

In some implementations, a search system that employs a generative model where the significance scores are embedded via a mask ensures that responses to prompts that are provided by the model are primarily influenced by the most credible and trustworthy sources. In some cases, an embedded mask allows the generative model to apply a more holistic approach to a scoring function used to generate responses. Put another way, the model considers scoring for all of the sources relevant to a prompt according to the embedded mask). For example, the embedded mask highlighting “better” sources (e.g., CNN vs. reddit) and therefore, when a snippet is attributed to a “better” source (e.g., CNN), the generative model, via the mask, assigned greater weight to information attributed to the better source than to information attributed to a lesser source. Thus, improving the overall reliability and accuracy of the provided information.

In some examples, an attention allocation process includes a query or prompt that represents a current focus of a generative model (e.g., a word in a sentence or a region in an image). The attention allocation process may also include a key that represents the parts of the input that the model is considering for attention and a value that is the actual content of the input used to compute the output weighted by the attention scores according to the embedded mask. In adaptive attention, the way the model assigns weights (or how it decides what to focus on) can change dynamically, based on factors such as input characteristics (e.g., the importance of information attributed to a particular source), task requirements (e.g., different tasks might need attention to different parts of the input), and contextual information. In some implementations, an embedded mask adjusts the attention weights based on the input's characteristics. For example, the attention distribution may focus more heavily on the content from a higher ranked source rather than content from a lower ranked source.

In some examples, implementations of the described system incorporate source reliability and credibility information into the response generation process of search engine systems that leverage LLMs and RAG models. In an example implementation, a reward model is trained to learn the optimal correlation between the significance scores (e.g., credibility score, relevancy score, page rank, and the like) of retrieved sources and the expected attention that these sources should receive during response generation. The reward model trains (e.g., using a supervised fine-tuning process) the LLM by providing feedback that causes the model to allocate attention that more effectively aligns with the credibility of the sources. More specifically, the reward model may be fed, from the LLM, an input of various snippets (content provided via a source) that are responsive to a query and scores (credibility scores) associated with the sources of the snippets. Given two or more outputs from the LLM the reward model provides feedback as to which output is preferred. The reward model is trained to reward outputs that use higher credibility scores and punish outputs that use lower scores.

A reward model, primarily used in reinforcement learning, is a function that assigns a numerical value (reward) to an agent’s actions based on the current state, essentially acting as a feedback mechanism to guide the agent towards desired behaviors by incentivizing actions that lead to higher rewards and discouraging those that lead to lower rewards. The reward model plays a crucial role in shaping the learning process by indicating how well an agent is performing in a given situation Accordingly, when trained by the reward model, the LLM learns to automatically prioritize high-scoring sources and to give appropriate weight/attention to snippets based on the respective scores of the source. Leads to a continuous improvement in the reliability and trustworthiness of the search engine’s outputs.

### Example Environment

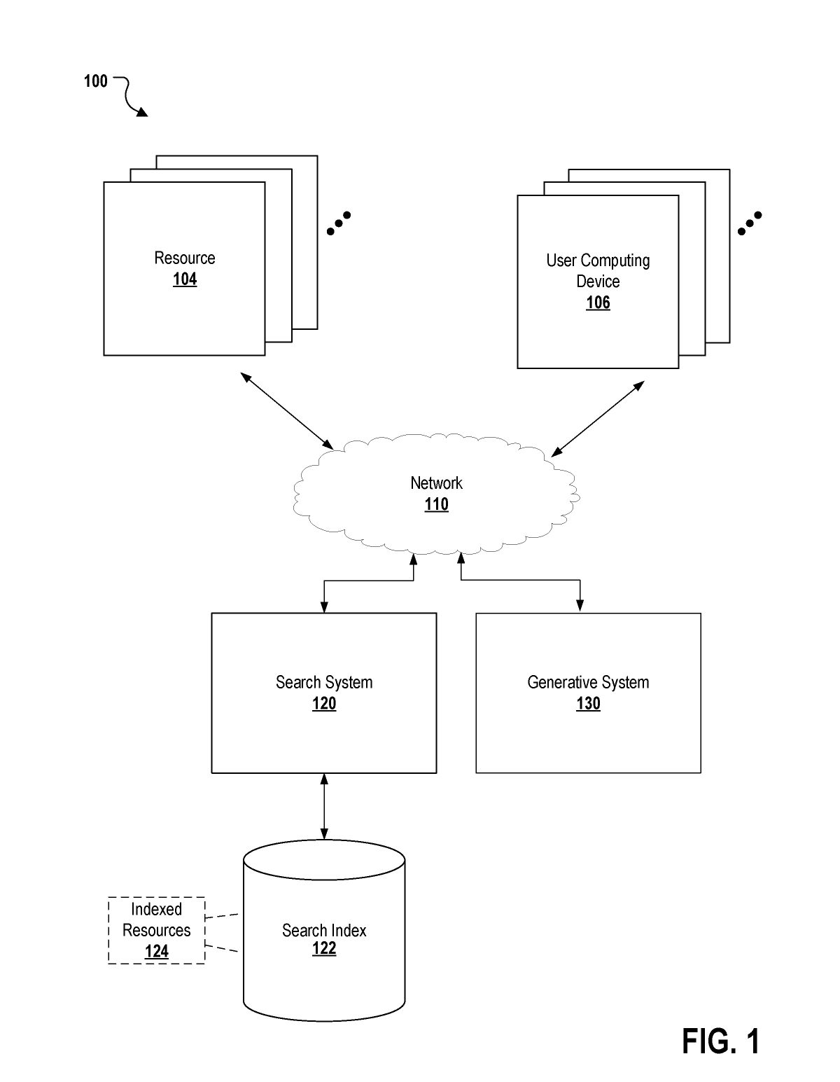

FIG. 1 is a block diagram of an example architecture in which users can interact with one or more generative models where prior knowledge has been injected using various approaches to help steer and/or control generated responses. As depicted, a communications network 110 connects user computing devices 106 with a search system 120, a generative system 130, and resources 104. The communications network 110 may include wireless and wired portions that may be accessed over a wired and/or a wireless communications link. For example, user computing devices 106, such as smartphones can use a cellular network to access the communications network 110. The environment 100 may include millions of resources 104 (e.g., provided via web site) and user computing devices 106. In some cases, the communications network 110 is implemented using one or more existing networks, for example, a cellular network, the Internet, a land mobile radio (LMR) network, a BLUETOOTH network, a wireless local area network (for example, Wi-Fi), a wireless accessory Personal Area Network (PAN), a Machine-to-machine (M2M) network, and a telephone network. The communications network 110 may also include future developed networks. In some implementations, the communications network 110 includes the Internet, an intranet, an extranet, or an intranet and/or extranet that is in communication with the Internet. In some implementations, the communications network 110 includes a telecommunication or a data network.

As used herein, resources 104 can refer to any content accessible by an identifier by a search engine or content, such as a dialog, provided by the user computing device 106 (e.g., in addition to the query). Thus, resources 104 may include web resources, documents, media (e.g., multimedia content), programming elements, and the like. Other example web resources include, but are not limited to, text, images files, video files, audio files, feed sources, and the like.

A web resource (e.g., a web page) includes data that can be provided over the communications network 110 via a resource address (e.g., a uniform resource locator (URL)). In some cases, the web resources 104 are formatted in a markup language (e.g., hypertext markup language (HTML), extensible markup language (XML), and the like). In some cases, the resources 104 (e.g., web resources) include embedded information such as metadata information, hyperlinks, embedded instructions (e.g., scripts) and the like. In some cases, the resources 104 are published by a resource provider via a website. Such a website may include a collection of the resources 104.

In some cases, the search system 120 and the generative system 130 as well as publishers of some of the resources 104 are associated with a domain(s) and hosted by one or more servers in one or more locations. In some cases, these one or more servers include a server-class hardware type device and/or computer systems using clustered computers and components to function as a single pool of seamless resources when accessed through the communications network 110. For example, such implementations may be used in data center, cloud computing, storage area network (SAN), and network attached storage (NAS) applications. In some implementations, the one or more servers are deployed using a virtual machine(s).

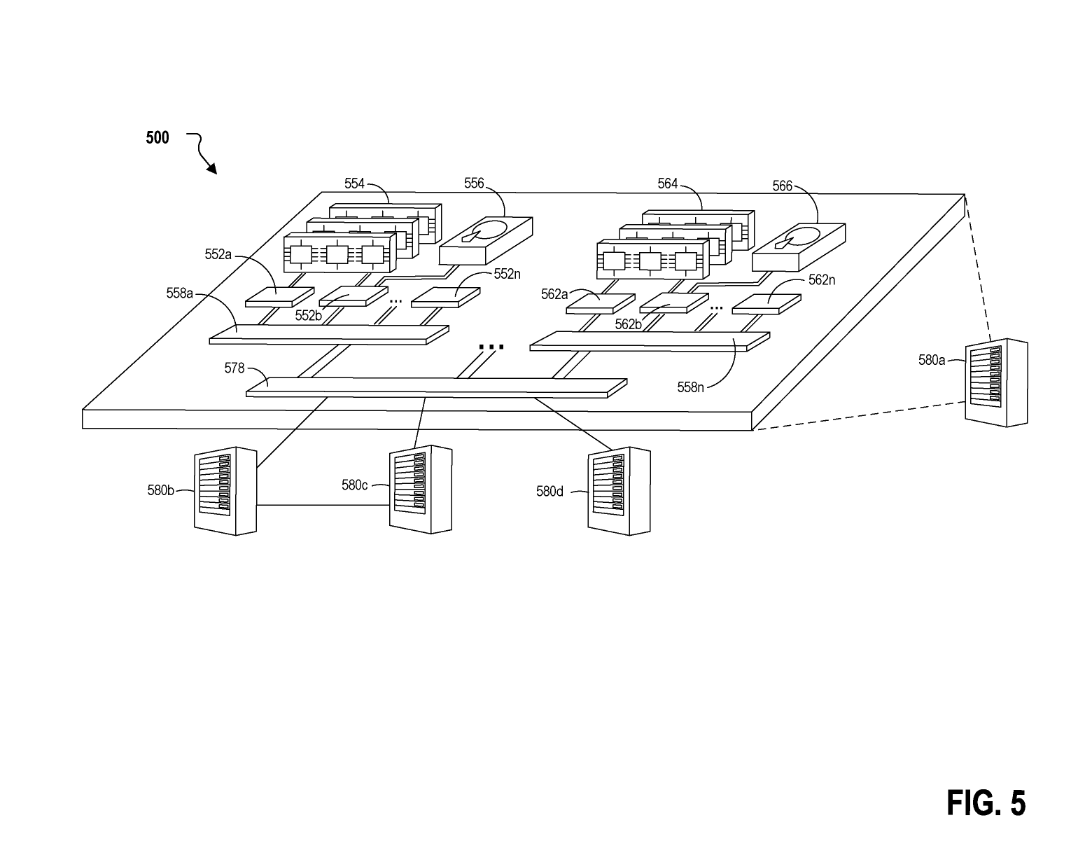

In some implementations, user computing device(s) 106 is an electronic device capable of requesting and receiving resources over the communications network 110. In some implementations, user computing device 106 is sustainably similar to the computing device 500 described below with reference to FIG. 5. Example user computing devices 106 include personal computers, mobile communication devices, tablet computers, Extended Reality (XR) devices, and the like. The user computing devices 106 may include (e.g., may each include) any appropriate type of computing device, such as a desktop computer, a laptop computer, a handheld computer, a tablet computer, a personal digital assistant (PDA), an augmented reality (AR) / virtual reality (VR) device, a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In some implementations, the search system 120 accesses a search index 122 to search resources 104. In some implementations, the search index 122 includes a datastore of resources 104 (indexed resources 124) generated by crawling the information (e.g., web sites) provided by the publisher of the resource 104. In some implementations, the search index 122 is a repository for persistently storing and managing collections of data. Example data stores, such as the search index 122, that may be employed within the described system include data repositories, such as a database as well as simpler store types, such as files, emails, and so forth. In some implementations, the search index 122 includes a database. In some implementations, a database is a series of bytes or an organized collection of data that is managed by a database management system (DBMS).

In some implementations, the user computing devices 106 are configured to submit search queries to the search system 120 (e.g., via a web service provided by the search system 120). In some implementations, in response to each query, the search system 120 is configured to identify resources that are relevant to the query from the information stored in the search index 122. For example, the search system 120 may, for example, identify the resources 104 in the form of search results. Once generated, the search results are provided as part of a search result page to the user computing device 106 from which the query was received.

In some examples, a user computing device 106 can include one or more input modalities. Example input modalities can include a keyboard, a touchscreen, a mouse, a stylus, and/or a microphone. For example, a user can use a keyboard and/or touchscreen to type in a search query. As another example, a user can speak a search query, the user speech being captured through the microphone, and processed through speech recognition to provide the search query.

In response to receiving a search query, the search system 120 processes the query and accesses the search index 122 to identify resources 104 that are relevant to the search query (e.g., have at least a minimum specified relevance score for the search query). The search system 120 identifies the resources 104, generates a search result page. a search result page is generated by the search system 120 in response to a query. The search result page includes search results and can include other content, such as ads, knowledge panels, short answers, other types of rich results, links to limit the search to a particular resource type (e.g., images, travel, shopping, news, videos, etc.), other suggested searches, and the like. The resources were determined to be responsive to the query by the search engine. The search result includes a link to a corresponding resource. Put another way, each search result represents/is associated with a resource. The search result can include additional information, such as a title, a portion of text obtained from the content of the resource (e.g., a snippet), an image associated with the resource, etc., or other information relevant to the resource and/or the query, as determined by the search engine of the search system 120.

In some implementations, the generative system 130 trains and uses a generative model to provide responses to queries provided by the user computing devices 106. In some implementations, the generative system 130 may be co-located with the search system 120. In other words, in some implementations the generative system 130 and the search system 120 may be operated at the same server, which may be a distributed server. In some cases, the generative system 130 is supported by the search system 120; however, implementations are not limited to Internet search engines and can be supported by other types of search engines that are configured to provide resources responsive to a query.

In disclosed implementations, the generative system 130 may also send a query to the search system 120. The generative system 130 may use an application programming interface (API) of the search engine of the search system 120. The search engine API may return search results in a way that is not formatted for display, but instead enables the generative system 130 to read, analyze, and further process the information in a search result (e.g., the resource address, the relevant text extracted from the content, the title, etc.). In addition, the search engine API may enable the generative system 130 to request properties of the returned search results.

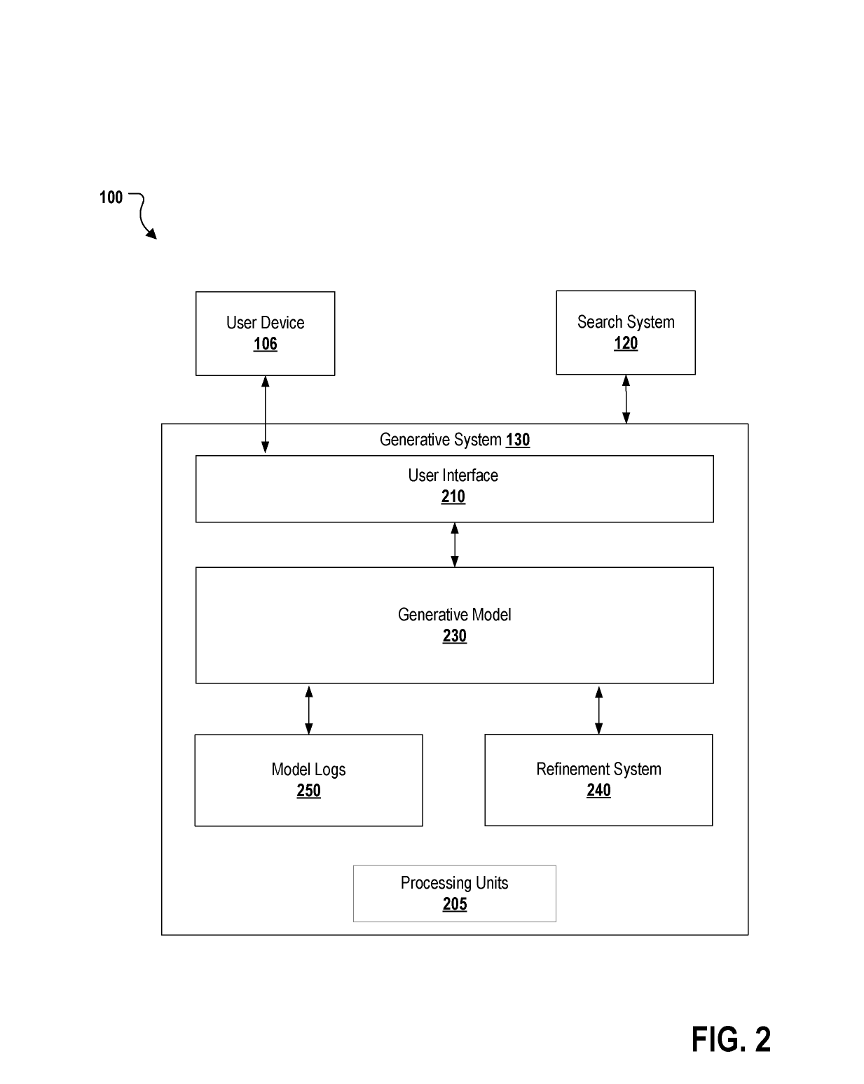

In accordance with implementations of the present disclosure, the example environment 100 also includes generative system 130 communicably coupled to the search system 120 (e.g., directly coupled or coupled over a network such as communications network 110). The generative system 130 may also be communicably coupled to a web site that provides one or more of the resources 104 and/or one or more of the user computing devices 106. In some implementations, the generative system 130 includes a generative model and is described in more detail with respect to FIG. 2.

FIG. 2 is a diagram that illustrates an example of the generative system 130, according to disclosed implementations. One or more of the components of the generative system 130 can be, or can include processors (e.g., processing units 205) configured to process instructions stored in a memory. Examples of such instructions as depicted in FIG. 2 include the user interface 210, generative model 230, refinement system 240, and model logs 250.

The user interface 210 is configured to receive prompts from the user device 106. A prompt can be any input received from the user device 106 (e.g., via user interface 210). In some examples, a prompt may include data and a query related to the data. For example, a prompt may include a query (e.g., provide a summarization of a particular topic based on a number of corpora) and preferred sources and/or corpora of the user. In some implementations, user interface 210 receives the prompts over a network interface, i.e., over a network such as the communications network 110. The user interface 210 can be configured to display a prompt input area. The prompt input area may take text as input. The user interface 210 may also be configured to display a response to the provided prompt. In some implementations, the user interface 210 may be part of (included in) another user interface. For example, the user interface 210 can be part of a search engine user interface, a browser tool or extension, a document extension or add in, and the like.

The user interface 210 may be configured to display a session. The user interface 210 may be configured to display a portion of a session. In some cases, a session includes prompts and responses (prompt rounds) and can be defined by a user. For example, the user interface 210 may include a control that enables the user to expressly start a new session. A session can be defined by a predetermined number of prompt rounds (a round being a prompt and its corresponding response). In such an implementation, a new session may begin after the predetermined number of prompt rounds. A session can be defined by a tab or window. For example, a session may encompass all prompt rounds occurring within the browser tab in which the user interface 210 is presented. In some implementations, the generative system 130 can expressly end a session based on some criteria (e.g., based on a topic or other characteristic of a prompt, number of prompt rounds, and so forth). An indication of the new session may be included in a final response for an ending session. A session is part of a prompt context. A prompt context can thus include a current prompt and the prior prompt rounds. If no prior prompt rounds exist, the prompt context may include the current prompt. In some implementations, the prompt context can include metadata (e.g.,). The metadata can include a number of prior prompt rounds. The metadata can include, with user permission, information about content displayed on a display of the user device 106, a topic and/or entity determined from the content displayed on the display, information about the user device 106 and/or user preferences (with user permission) relevant to the prompt, and the like.

In some implementations, the user interface 210 is configured to provide a prompt to the generative model 230. The generative model 230 includes an embedded mask that dynamically adjusts the model’s attention allocation based on the embedded (e.g., via a mask) significance scores by setting higher attention weights for blocks of text associated with higher credibility scores. In some cases, the mask focuses the generative model 230 on the most reliable sources of information during response generation. In some examples, the generative system 130 includes the mask to embed significance scores to ensure that responses to prompts that are provided by the model are primarily influenced by the most credible and trustworthy sources. In some cases, the embedded mask allows the generative model to apply a more holistic approach to a scoring function used to generate responses.

In some implementations, the generative system 130 may generate model logs 250. Model logs 250 includes log records that capture a session. A session record includes at least a prompt and the generated response. Some session records in the model logs 250 may also capture the provided conversation and/or a summary of the conversation. The model logs 250 may be used by the refinement system 240 to generate training data used by the generative system 130 to further refine (fine-tune, train) the generative model 230. The refinement system 240 is configured to generate training data used to further train (refine) the generative model 230. The training data can include labeled training examples to assist with various training techniques, such as few-shot training.

### Example Processes

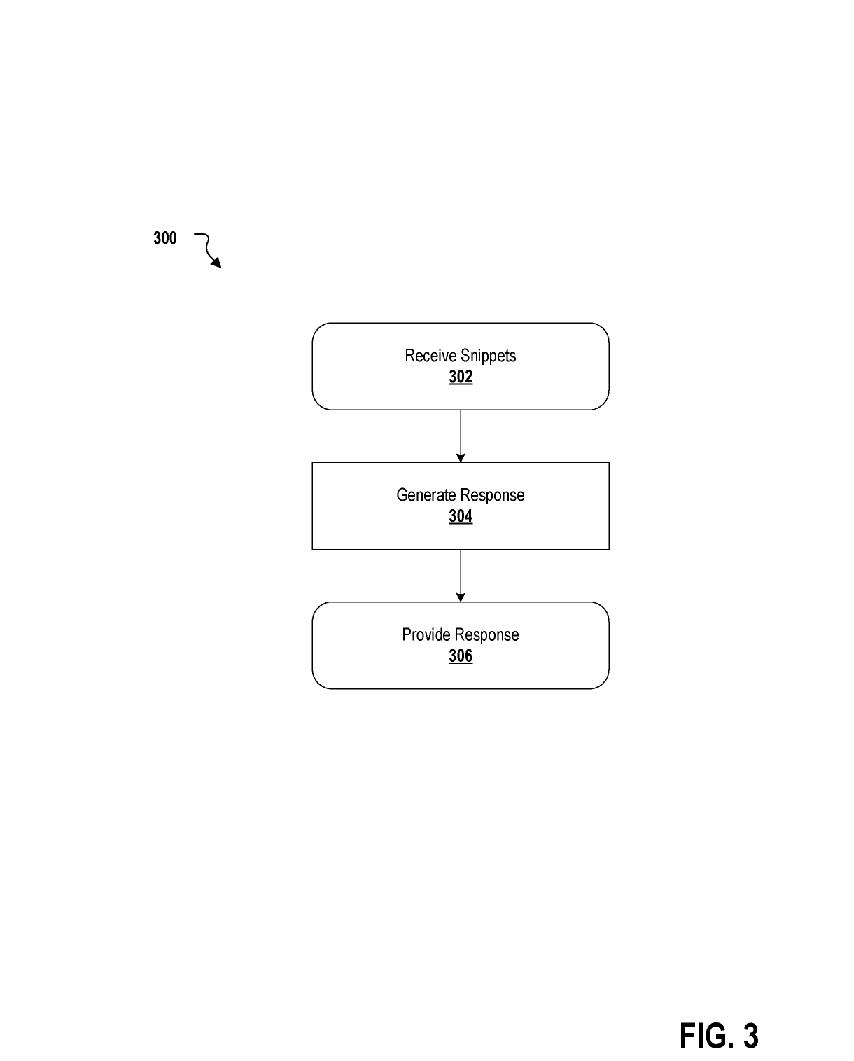

FIG. 3 depicts a flowchart of an example process 300 respectively that can be implemented by implementations of the present disclosure. The example process 300 can be implemented by systems and components described with reference to FIGS. 1 and 2. The example process 300 shows in more detail incorporating source reliability and credibility information into the response generation process of search engine systems that leverage generative models.

For clarity of presentation, the description that follows generally describes the example process 300 in the context of FIGS. 1 and 2. However, it will be understood that the process 300 may be performed, for example, by any other suitable system, environment, software, and hardware, or a combination of systems, environments, software, and hardware as appropriate. In some implementations, various operations of the process 300 can be run in parallel, in combination, in loops, or in any order.

At 302, a plurality of snippets responsive to a query are received. In some implementations, each snippet of the plurality of snippets is associated with a credibility score. From 302, the process 300 proceeds to 304 where a response to the query is generated by processing the plurality of snippets and associated credibility scores through a generative model that includes a mask configured to adjust attention weights associated with the plurality of snippets based on the respective credibility scores. From 304, the process 300 proceeds to 306 where the response to the query is provided via the search system. From 306, the process 300 ends or repeats.

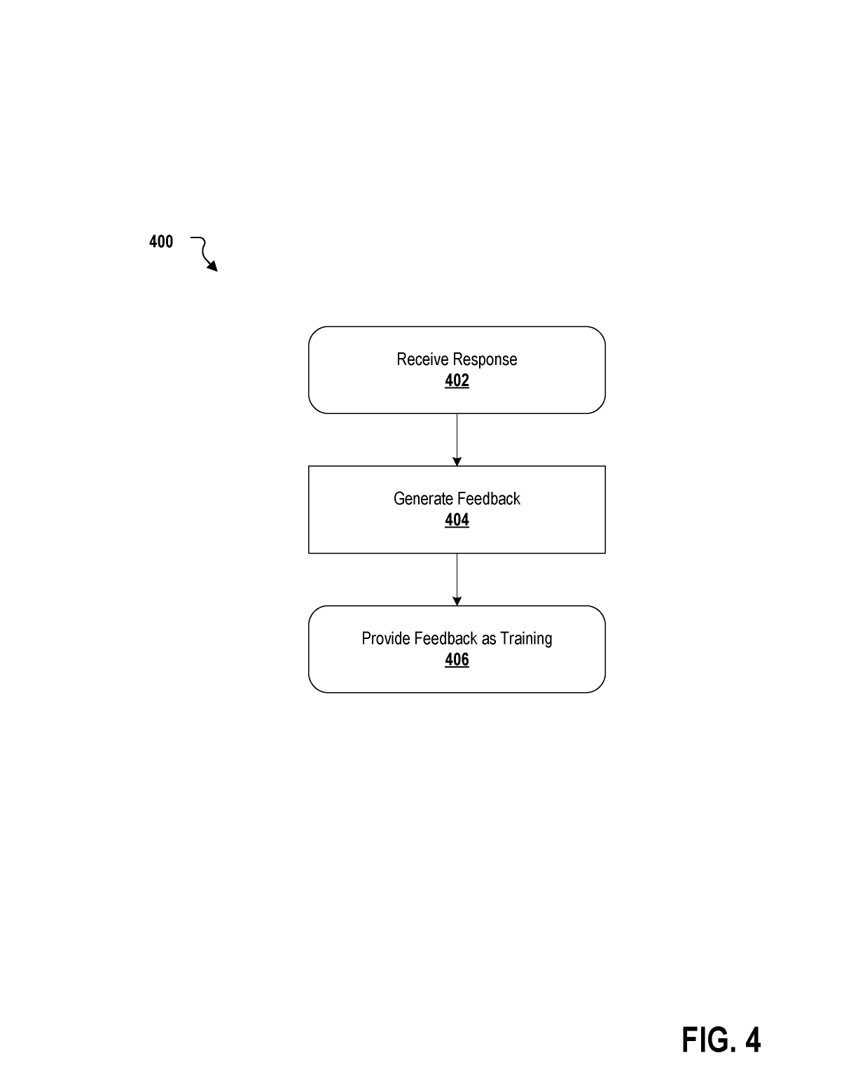

FIG. 4 depicts a flowchart of an example process 400 respectively that can be implemented by implementations of the present disclosure. The example process 400 can be implemented by systems and components described with reference to FIGS. 1 and 2. The example process 300 shows in more detail incorporating source reliability and credibility information into the response generation process of search engine systems that leverage generative models via a reward model used to train the generative model.

For clarity of presentation, the description that follows generally describes the example process 400 in the context of FIGS. 1 and 2. However, it will be understood that the process 400 may be performed, for example, by any other suitable system, environment, software, and hardware, or a combination of systems, environments, software, and hardware as appropriate. In some implementations, various operations of the process 400 can be run in parallel, in combination, in loops, or in any order.

At 402, a response based on a plurality of snippets responsive to a query and an aggregate score associated with the response is received from a generative model. The aggregate score is determined based on a plurality of credibility scores. Each credibility score of the plurality of credibility scores is associated with a respective snippet of the plurality of snippets. The aggregate score reflects a weight assigned by the generative model to each snippet of the plurality of snippets based on the respective credibility score of the plurality of credibility scores. In some implementations, the response is a first response and the aggregate score is a first aggregate score. In some implementations, the plurality of snippets and the plurality of credibility scores are provided via a search system based on the query.

From 402, the process 400 proceeds to 404 where feedback from the generative model is generated by processing the response and the aggregate score through a reward model. In some implementations, the feedback includes a selection of the first response as a selected response or a selection of a second response as the selected response based on the first aggregate score and a second aggregate score associated with the second response. In some implementations, the reward model is trained to select the first response or the second response as the selected response based on the first aggregate score, the second aggregate score, and a threshold value.

From 404, the process 400 proceeds to 406 where the feedback is provided as training to the generative model. In some implementations, the generative model is trained to provide responses to queries received by the search system. From 406, the process 400 ends or repeats.

### Example System

FIG. 5 shows an example of a computing device 500, which may be generative system 130 of FIGS. 1 and 2, which may be used with the techniques described here. The example computing device 500 can be programmed or otherwise configured to implement systems or methods of the present disclosure. Computing device 500 is intended to represent various example forms of large-scale data processing devices, such as servers, blade servers, data centers, mainframes, and other large-scale computing devices. Computing device 500 may be a distributed system having multiple processors, possibly including network attached storage nodes, that are interconnected by one or more communication networks. The components shown here, their connections and relationships, and their functions, are meant to be examples only, and are not meant to limit implementations of the implementations described and/or claimed in this document.

Computing device 500 may be a distributed system that includes any number of computing devices 580 (e.g., 580a, 580b, … 580n). Computing devices 580 may include a server or rack servers, mainframes, and the like, communicating over a local or wide-area network, dedicated optical links, modems, bridges, routers, switches, wired or wireless networks, etc.

In some implementations, each computing device may include multiple racks. For example, computing device 580a includes multiple racks (e.g., 558a, 558b, …, 558n). Each rack may include one or more processors, such as processors 552a, 552b, …, 552n and 562a, 562b, …, 562n. The processors may include data processors, network attached storage devices, and other computer-controlled devices. In some implementations, one processor may operate as a master processor and control the scheduling and data distribution tasks. Processors may be interconnected through one or more rack switches 562a - 562n, and one or more racks may be connected through switch 578. Switch 578 may handle communications between multiple connected computing devices 500.

Each rack may include memory, such as memory 554 and memory 564, and storage, such as 556 and 566. Storage 556 and 566 may provide mass storage and may include volatile or non-volatile storage, such as network-attached disks, floppy disks, hard disks, optical disks, tapes, flash memory or other similar solid state memory devices, or an array of devices, including devices in a storage area network or other configurations. Storage 556 or 566 may be shared between multiple processors, multiple racks, or multiple computing devices and may include a non-transitory computer-readable medium storing instructions executable by one or more of the processors. Memory 554 and 564 may include, e.g., volatile memory unit or units, a non-volatile memory unit or units, and/or other forms of non-transitory computer-readable media, such as a magnetic or optical disks, flash memory, cache, Random Access Memory (RAM), Read Only Memory (ROM), and combinations thereof. Memory, such as memory 554 may also be shared between processors 552a-552n. Data structures, such as an index, may be stored, for example, across storage 556 and memory 554. Computing device 500 may include other components not shown, such as controllers, buses, input/output devices, communications modules, and the like.

An entire system may be made up of multiple computing devices 500 communicating with each other. For example, device 580a may communicate with devices 580b, 580c, and 580d, and these may collectively be known as search system 120. Some of the computing devices may be located geographically close to each other, and others may be located geographically distant. The layout of computing device 500 is an example only and the system may take on other layouts or configurations.

It should also be understood that although certain drawings illustrate hardware and software located within particular devices, these depictions are for illustrative purposes only. In some implementations, the illustrated components may be combined or divided into separate software, firmware, or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links

Moreover, various implementations of the systems and techniques described herein can be realized in digital electronic circuitry, integrated circuitry, specially designed ASICs (application specific integrated circuits), computer hardware, firmware, software, or combinations thereof. These various implementations can include implementation in one or more computer programs that are executable or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include computer readable or machine instructions for a programmable electronic processor and can be implemented in a high-level procedural or object-oriented programming language, or in assembly/machine language. As used herein, the terms “machine-readable medium” and “computer-readable medium” refers to any computer program product, apparatus or device (e.g., magnetic discs, optical disks, memory, Programmable Logic Devices (PLDs)) used to provide machine instructions or data to a programmable processor, including a machine-readable medium that receives machine instructions as a machine-readable signal. The term “machine-readable signal” refers to any signal used to provide machine instructions or data to a programmable processor.

The functionality of the computer readable instructions may be combined or distributed as desired in various environments. In some implementations, a computer program includes one sequence of instructions. In some implementations, a computer program includes a plurality of sequences of instructions. In some implementations, a computer program is provided from one location. In other implementations, a computer program is provided from a plurality of locations. In various implementations, a computer program includes one or more software modules. In various implementations, a computer program includes, in part or in whole, one or more web applications, one or more mobile applications, one or more standalone applications, one or more web browser plug-ins, extensions, add-ins, or add-ons, or combinations thereof.

Unless otherwise defined, the technical terms used herein have the same meaning as commonly understood by one of ordinary skill in the art to which the present subject matter belongs. As used in this specification and the appended claims, the singular forms “a,” “an,” and “the” include plural references unless the context clearly dictates otherwise. Any reference to “or” herein is intended to encompass “and/or” unless otherwise stated.

A number of implementations have been described. Nevertheless, it will be understood that various modifications may be made without departing from the spirit and scope of the disclosed implementations. While preferred implementations of the present disclosure have been shown and described herein, it will be obvious to those skilled in the art that such implementations are provided by way of example only. Numerous variations, changes, and substitutions will now occur to those skilled in the art without departing from the described system. It should be understood that various alternatives to the implementations described herein may be employed in practicing the described system.

Moreover, the separation or integration of various system modules and components in the implementations described earlier should not be understood as requiring such separation or integration in all implementations, and it should be understood that the described components and systems can generally be integrated together in a single product or packaged into multiple products. Accordingly, the earlier description of example implementations does not define or constrain this disclosure. Other changes, substitutions, and alterations are also possible without departing from the spirit and scope of this disclosure.

What is claimed is:

1. A method comprising:
receiving a plurality of snippets responsive to a query, wherein each snippet of the plurality of snippets is associated with a respective credibility score;
generating a response to the query by processing the plurality of snippets and respective credibility scores through a generative model that includes a mask configured to adjust attention weights associated with the plurality of snippets based on the respective credibility scores; and
providing the response to the query via a search system.

2. The method of claim 1, wherein a respective credibility score for a snippet is based on a source of the snippet.

3. The method of claim 1, further comprising generating the mask based on the plurality of snippets and the respective credibility scores.

4. A method comprising:
receiving, from a generative model, a response based on a plurality of snippets responsive to a query and an aggregate score associated with the response, the aggregate score determined based a plurality of credibility scores, wherein each credibility score of the plurality of credibility scores is associated with a respective snippet of the plurality of snippets, wherein the aggregate score reflects a weight assigned by the generative model to each snippet of the plurality of snippets based on the respective credibility score of the plurality of credibility scores;
generating feedback from the generative model by processing the response and the aggregate score through a reward model; and
providing the feedback as training to the generative model.

5. The method of claim 4, wherein the response is a first response and the aggregate score is a first aggregate score, and wherein the feedback includes a selection of the first response as a selected response or a selection of a second response as the selected response based on the first aggregate score and a second aggregate score associated with the second response.

6. The method of claim 4, wherein the feedback guides the generative model to allocate more attention to snippets associated with higher credibility scores.

7. The method of claim 4, wherein the plurality of snippets and the plurality of credibility scores are provided via a search system based on the query.

8. The method of claim 7, wherein the generative model is trained to provide responses to queries received by the search system.
